(19) United States
(12) Patent Application Publication
(10) Pub. No.: US 2026/0278883 A1
(43) Pub. Date: Sep. 17, 2026

(54) TEXT TO IMAGE SYSTEM WITH ENHANCED TEXT ADHERENCE, RESIDUAL BLOCK MODULATION FOR MODEL TRAINING, AND ADAPTIVE TEXT ENCODING

(71) Applicant: Reve AI, Inc., Palo Alto, CA (US)

(72) Inventors: Mohammad Taghi SAFFAR, Palo Alto, CA (US); Michaël Yanis GHARBI, Palo Alto, CA (US)

(21) Appl. No.: 19/561,775

(22) Filed: Mar. 10, 2026

Related U.S. Application Data
(60) Provisional application No. 63/772,167, filed on Mar. 14, 2025.

(51) Int. Cl. G06T 11/60; G06F 40/284

(52) U.S. Cl. CPC G06T 11/60; G06F 40/284

(57) ABSTRACT

A system may access input text that describes an image to be generated. The system may generate a plurality of text tokens based on the input text. The system may transform, in a first transformer layer of the text2image model, the plurality of text tokens based on self-attention in which an importance of a text token is weighted relative to other ones of the plurality of text tokens. The system may transform, in a second transformer layer of the text2image model, a plurality of image tokens based on self-attention in which an importance of an image token is weighted relative to other ones of the plurality of image tokens. The system may perform cross-attention between the transformed plurality of text tokens and the transformed plurality of image tokens. The system may generate an output image based on the cross-attention.

### CROSS-REFERENCE TO RELATED APPLICATIONS

This application claims priority to U.S. Provisional Application No. 63/772,167, filed Mar. 14, 2025, the subject matter of which is incorporated herein by reference in its entirety.

### BACKGROUND

Text-to-image (“text2image”) models are trained to generate images based on text inputs. For example, when a user provides a text input, “cat sitting on a hill,” a text2image model should generate an image of a cat sitting on a hill. Diffusion models, and their variants, have been the main framework for training and sampling text2image models. Various model architectures have been proposed for diffusion/rectified flow training as well. UNets and Diffusion Transformers (DiTs) are two major categories that may be used for text2image models. UNets are usually composed of convolutions and transformer layers that operate at multiple resolutions. DiTs are usually composed of just transformer layers that operate at a single resolution. DiTs inherit the advantages of a standard transformer model, such as ease of use, scalability, stability at large scale, and extensive tooling support because DiTs are similar to Large Language Models (LLMs) from an architectural perspective.

### SUMMARY

Though growing increasingly powerful, training and executing image2text models have various problems, such as text adherence, training at large scale, and literal text rendering in generated images.

Text adherence is a problem in which a text2image model should, but oftentimes does not, closely follow a user's instruction to generate an image. Text adherence problems may be caused by transformer adaptations to text2image models that account for the different input/output (I/O) modality as compared to LLMs. For example, the output of text2image models is image tokens and the input is text tokens. Transformers may be adapted to serve the specialized needs of text2image problems in part because of this I/O modality. In particular, some text2image models (such as some DiT models) employ a layer called “Joint Attention.” In this layer, text and image tokens may be concatenated in their sequence length dimension and then a self-attention computation is performed on the joint sequence. This means that image and text tokens can “attend” to each other under the same self-attention computation. However, this joint attention can result in situations in which a self-attention computation forces image and text tokens to “compete” with each other to influence the output. This problem is especially severe at the low noise regime in diffusion and the model learns to always prefer looking at adjacent image tokens and ignore the text tokens for minimizing its denoising objective, thereby diminishing text adherence.

To address the text adherence issue, the system may employ a separate trainable stack of transformer layers on the input text tokens that perform “self-attention” between text tokens, and also split the image attention computation into “self-attention” between image tokens and “cross attention” between the self-attended text tokens and the self-attended image tokens. In this architecture, self-attention and cross attention are now separate and the influence of text and image tokens in the outputs are controlled via the residual connections in the network. Thus, both token types have a reasonable chance to influence the output at various noise scales.

Training at scale can be problematic for text2image models. For example, a goal of training text2image models is to ensure loss is decreased smoothly and gradient norms are not spiky. One source of issues regarding large model training comes from the interaction between residual connections, computation precision and the difference in activation magnitudes in the residual summations. Standard transformer layers consists of blocks of computations that are getting their input from a backbone and their outputs are summed with the backbone activations. When a network is deep enough, contributions of the previous layers to the activation backbones start to accumulate and can cause the vector magnitudes to grow very rapidly. This can cause the contribution of the later stages of the network to be completely overpowered by the backbone activations because summation of vectors with vastly different magnitudes at low precision, causes underflow.

To address this issue, the system may use a transformer block architecture that modulates the magnitude of the residual blocks and normalizes it back to have a predefined magnitude. Instead of a normal summation between backbone and residual block activations, the system may employ a “gated” summation which is a weighted summation that is controlled by a multiplicative factor referred to herein as “gate”. This means that the activation norm of the backbone does not grow arbitrarily large and each layer in the network has an opportunity to influence the output. This results in stable training dynamics that avoids loss or gradient norm blow ups even at very long training horizons.

A text2image model should also be able to produce different image styles such as photo-realistic, cartoon, designs, and so forth. Text2Image models should also provide literal “text rendering” capabilities in which input text is written, verbatim, into the image. However, in conventional models, this task can require a vast amount of world knowledge and precise pixel level reasoning, among other considerations. For example, some text2image models incorporate a pre-trained text encoder, such as Text-to-Text Transfer Transformer in their model architecture. Text encoders are trained with tokenizers that are efficient and result in fewer tokens to represent a given text, compared to byte level tokenizers. However, this efficiency gain is at the cost of having to learn how to “spell” different text tokens, which is exponentially more varied than a simple alphabet like the English alphabet.

To address this issue, the disclosure relates to adaptive text encoding that improves a text2image model's ability to perform literal text rendering. For example, the system may use a text renderer that uses a default tokenizer for parts of the prompt that describes the scene (image to be generated) and uses a character level tokenizer for parts of the prompt that describe what should be written in the image verbatim. To leverage a pre-trained text encoder and also benefit from this character level adaptive tokenization, the system may preprocess text inputs before tokenization. For example, the system may identify and tokenize parts of the text input that describe the image to be generated using a default or word-level encoding. The system may identify and tokenize parts of the text input that are intended for literal rendering in the image verbatim using a character-level encoding. This approach has the advantage of short sequence length for parts of the prompt that do not need verbatim text rendering capabilities and adaptively uses more tokens for character level encoding of parts of the text input. Thus, adaptive text encoding may enable the text2image model to perform advanced text rendering.

### BRIEF DESCRIPTION OF THE DRAWINGS

Features of the present disclosure may be illustrated by way of example and not limited in the following figure(s), in which like numerals indicate like elements.

FIG. 1 illustrates an example of a system environment for generating an image with improved adherence to text inputs, model training, and token embedding, according to an implementation.

FIG. 2 illustrates an example of a data flow for self-attention of text tokens, separate self-attention of image tokens, and cross-attention of the self-attended text tokens and the self-attended image tokens for enhanced text adherence in text2image models, according to an implementation.

FIG. 3 illustrates an example of a method for enhanced text adherence in a text2image model, according to an implementation.

FIG. 4 illustrates an example of a method for adaptive text encoding to process input text for text2image models, according to an implementation.

FIG. 5 illustrates an example of a method for training a text2image model based on a transformer block architecture that modulates the magnitude of the residual blocks and normalizes it back to have a predefined magnitude, according to an implementation.

### DETAILED DESCRIPTION

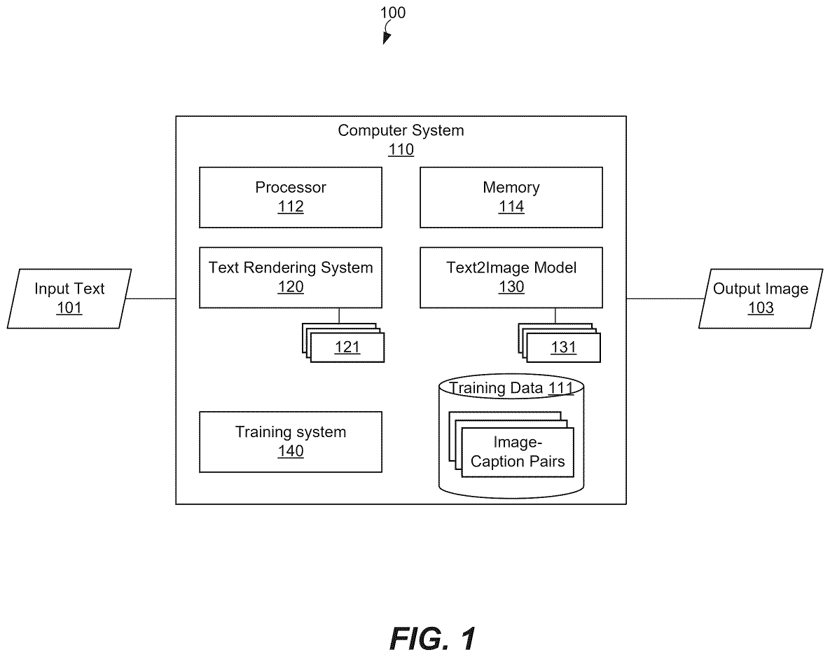

FIG. 1 illustrates an example of a system environment 100 for generating images from text, according to an implementation. The system environment 100 may include text2image models with enhanced text adherence and a transformer block architecture with residual block modulation for improved training, and adaptive text encoding of text input 101. The system environment 100 may include a computer system 110, which may generate an image 103 based at least on input text 101. The input text 101 may include words or phrases that describe a visual to be created. An image 103 is a computer-generated image. The image 103 may include a two-dimensional image or a three-dimensional image. The image 103 may be a static image such as a picture or a video (in which case the video can be composed of multiple frames of static images). The computer system 110 may include a processor 112, a memory 114, a text rendering system 120, a text2image model 130, a training system 140, and/or other features.

### Text Encoding

The text rendering system 120 may encode the input text 101 for processing by the text2image model 130. For example, the text rendering system 120 may be pretrained with a tokenizer that tokenizes the input text 101 into a plurality of text tokens 121. A text token is a portion of the input text 101. For example, a text token may be a word, a sub-word, an N-gram, a character, and/or other portion of the input text 101.

The tokenizer may perform tokenization in different ways. For example, for image generation, the tokenizer may perform higher-level tokenization in which generates fewer tokens are used to represent text as compared to byte-level tokenization that tokenizes at the character-level. In some examples, higher-level tokenization that uses fewer tokens may result in the text rendering system 120 having to learn how to “spell”, such as understand the context of, different text tokens, which may be exponentially more varied than a simple alphabet such as the English alphabet. While higher-level tokenization may result in compact text representation compared to, for example, byte-level encoders, this may also create a more complex vocabulary that must be learned. This complex vocabulary, in turn, increases the complexity of text-to-image models that must learn to effectively align complex text representations with visual features.

To address this issue, in some examples, the text rendering system 120 may adaptively encode the input text 101 (also referred to herein as performing “adaptive text encoding”). For example, the text rendering system 120 may adaptively encode the input text 101 by tokenizing different portions of the input text 101 using different tokenization techniques. In one example, the text rendering system 120 may perform higher-level tokenization on a portion of the input text 101 that describes the visual to be generated and byte-level tokenization on a portion of the input text 101 that is to be written in the visual verbatim, such as literal characters that should be written in the visual to be generated.

Doing so may enable the text rendering system 120 to take advantage of a pre-trained text encoder that performs efficient higher-level encoding, but also benefit from character-level adaptive tokenization for characters that are to be written in the visual. For example, the text rendering system 120 may identify one or more portions of the input text 101 that describe the visual to be generated and one or more portions of the input text 101 that are to be written to the visual. In some examples, the text rendering system 120 may identify the different portions of the input text 101 based on delimiters, tags, or other data that can be used to identify different portions of the input text 101.

In one example, the input text 101 may include double-quoted characters to signify that these characters should be written to the visual to be generated while non-double-quoted characters describe the visual to be generated. The input text 101: ‘a cat sitting on a hill “mytext”’ will be used to illustrate. The text rendering system 120 may identify a portion of the input string 101 that describes the visual to be generated as: ‘a cat sitting on a hill’ and use higher-level tokenization for this portion. The text rendering system 120 may identify another portion of the input text 101 ‘mytext’ to be literally written to the visual to be generated, and use byte-level (character-level) tokenization on this portion in which the portion is broken down into individual characters and tokenized separately. Other ways to delineate or otherwise label these portions may be used as well, such as tag-value pairs in which case the input text 101 may be provided as ‘description=cat sitting on a hill; write=mytext.’

Adaptive text encoding has the advantage of short sequence length for parts of the text input 101 that do not need verbatim text rendering capabilities and adaptively uses more tokens for character level encoding of parts of the prompt. This change in text encoding, enables the text 2 image model to perform state of the art text rendering which requires much less careful data curation and fine-tuning.

Once the input text 101 is tokenized, which may be via adaptive text encoding, the text rendering system 120 may vectorize, or embed the text tokens 121 in an embedding space. For example, the text rendering system 120 may vectorize the text tokens 121 using Text-to-Text Transfer Transformer, Bidirectional Encoder Representations from Transformers, and/or other techniques for generating embeddings. Although the result of embedding is typically a representation, in the examples that follow, the term “text tokens 121” will be used for clarity even though representations of the text tokens 121 are computationally processed by the text2image model 130. Likewise, the term “image tokens” will be used for clarity even though representations of the image tokens are computationally processed by the text2image model 130.

### Improved Prompt Adherence

The computer system 110 may use the text tokens 121 generated from the text rendering system 120 as a guide to generate the image 103. For example, the computer system 110 may execute a text2image model 130 to generate the image 103. The text2image model 130 may include a diffusion model, such as a Diffusion Transformer (DiT). In particular, the text2image model 130 may initialize a noisy image and generate an initial set of image tokens 131 from the noisy image. An image token 131 is a numerical vector representation of a portion of an image. For example, the initialized image generated by the diffusion model may be a noisy image that is denoised to generate the output image 103.

In some examples, the computer system 110 may execute a joint attention layer in which cross-attention is performed on the text tokens 121 and the image tokens 131. In the cross-attention, the text tokens 121 and image tokens 131 may be concatenated in their sequence length dimension and then a self-attention computation is performed on the joint sequence. The result is that the text tokens 121 and image tokens 131 can “attend” to each other under the same self-attention computation. In these examples, cross-attention may result in situations in which a self-attention computation forces the text tokens 121 and image tokens 131 to “compete” with one another to influence the output. This problem can be especially severe at the low noise regime in diffusion, in which case the model preferentially learns from adjacent image tokens 131 and ignores the text tokens 121 to minimize its denoising objective. In these cases, the output image 103 may not adhere to the input text 101. For example, some or all of the input text 101 may be ignored or not properly taken into account when generating the output image 103.

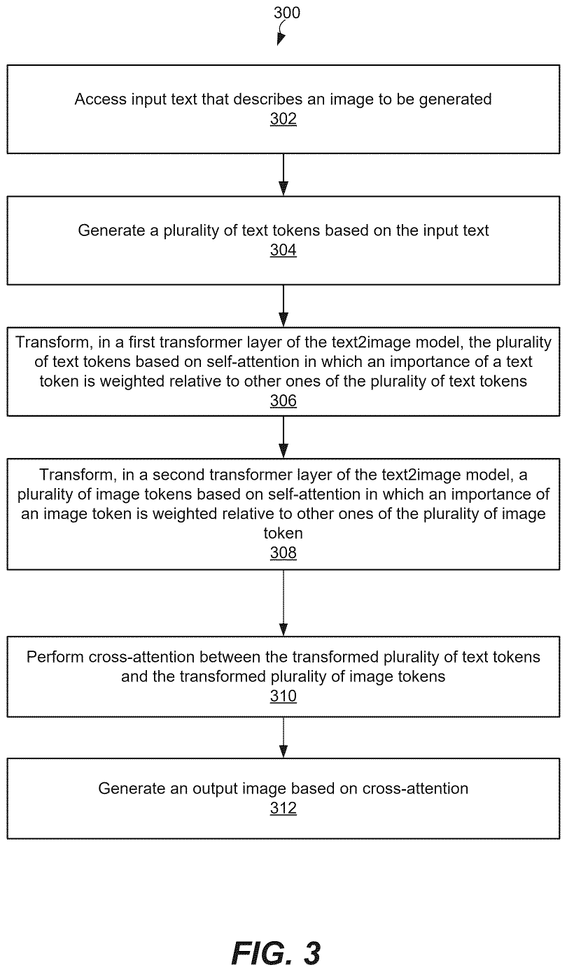

To address these issues, the text2image model 130 may execute a separate trainable stack of transformer layers on the text tokens 121. This separate trainable stack may perform self-attention between the text tokens 121 to generate transformed text tokens 121. The computer system 110 may further execute another trainable stack of transformer layers that perform self-attention on the image tokens 131 to generate transformed image tokens 131. The computer system 110 may then perform cross-attention between the transformed text tokens 121 and the transformed image tokens 131. This architecture separates self-attention and cross attention. As a result, the influence of text tokens 121 and image tokens 131 in the outputs are controlled via the residual connections in the transformer network, and both token types have a reasonable chance to influence the output at multiple (in some instances, all) noise scales. FIG. 3 and Table 1 illustrate further examples of the text2image model 130.

### Training Based on Modulation of the Magnitude of Residual Blocks

A goal of training an image model, such as the text2image model 130, is to make sure the loss is decreased smoothly and the gradient norms are not spiky. One source of issues regarding large model training comes from the interaction between residual connections, computation precision and the difference in activation magnitudes in the residual summations. Conventional transformer layers may include blocks of computations that obtain their input from a backbone. The outputs of the blocks of computations may be summed with the backbone activations. When a network is deep enough, contributions of the previous layers to the activation backbones start to accumulate and can cause the vector magnitudes to grow too quickly. This causes the contribution of the later stages of the network to be overpowered by the backbone activations because summation of vectors with vastly different magnitudes at low precision can cause underflow. Thus, even in the best trained models, removing the last few layers from the network usually do not cause any noticeable difference in the output.

In order to address this issue, the training system 140 may use a modified transformer block architecture to train the text2image model 130. The text2image model 130 may be trained using training data that includes a plurality of image-caption pairs. Each image-caption pair may include text stored in association with a corresponding image. The text may include text that describes the corresponding image. For example, the text may include a caption, a prompt, and/or other description of the corresponding image.

The modified transformer block architecture modulates the magnitude of the residual blocks and normalizes the magnitude to have a predefined magnitude. Instead of a normal summation between backbone and residual block activations, the modified transformer block architecture may use a “gated” summation. The gated summation is a weighted summation that may be controlled by a multiplicative factor (referred to as a “gate value”). In some examples, the gate value is a function of diffusion time.

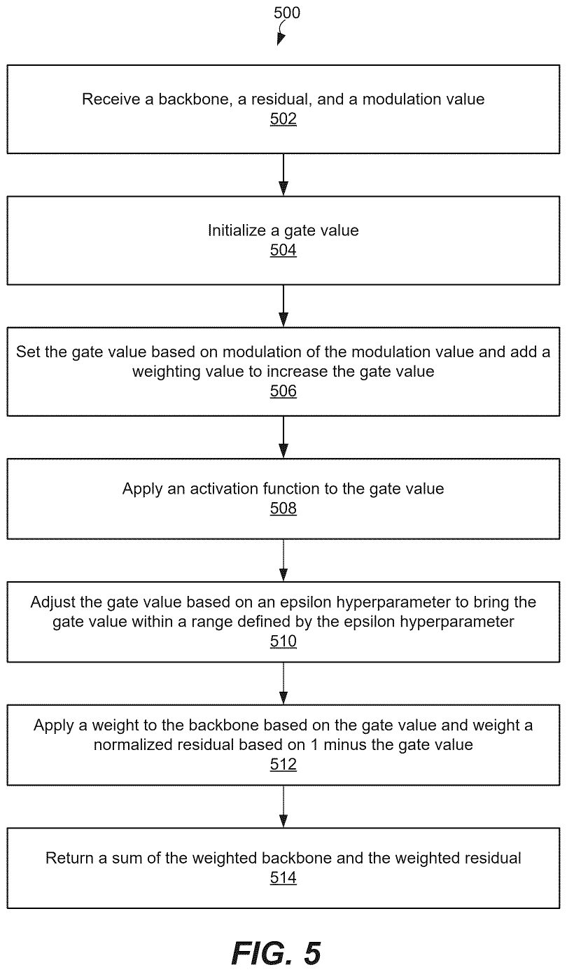

With gated summation, the activation norm of the backbone does not grow arbitrarily large and a given layer in the network (including the last few layers) may influence the output. In some examples, each layer in the network may equally influence the output. The modified transformer block architecture with gated summation may result in stable training dynamics that avoid loss or gradient norm blow ups, even at very long training horizons. Examples of training the text2image model 130 based on modulation of the magnitude of residual blocks are illustrated further in FIG. 5 and Table 2.

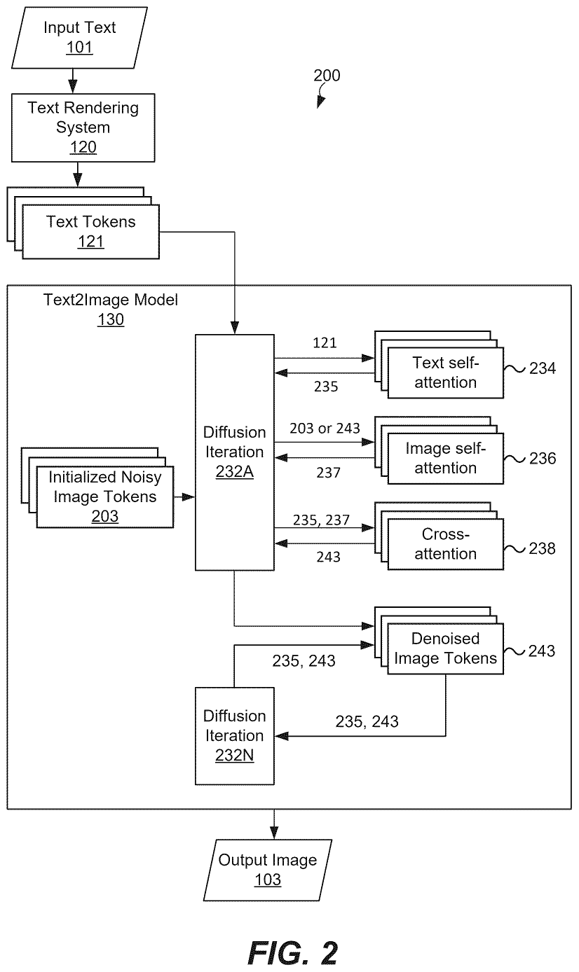

FIG. 2 illustrates an example of a data flow 200 for self-attention of text tokens, separate self-attention of image tokens, and cross-attention of the self-attended text tokens and the self-attended image tokens for enhanced text adherence in text2image models, according to an implementation. The text rendering system 120 may process input text 101 to generate text tokens 121. For example, the text rendering system 120 may tokenize the input text 101. In some examples, to tokenize the input text 101, the text rendering system 120 may perform adaptive text tokenization. The text rendering system 120 may embed the text tokens 121 into vectors for use by the text2image model 130.

In some examples, the text2image model 130 is a DiT model that is trained to generate images from text by denoising image tokens 131 through a plurality of denoising timesteps (illustrated as diffusion iterations 232A . . . 232N). The number of diffusion iterations 232 may be a model hyperparameter that can be adjusted as needed. While more diffusion iterations 232 can lead to higher image quality, this is also at the cost of increase computer resource usage and/or compute time. Only one diffusion iteration 232A is shown in greater detail for clarity. Other diffusion iterations 232N may include the illustrated functionality of the diffusion iteration 232A.

In an initial diffusion iteration 232, the text2image model 130 may generate an initial noisy image. The initial noisy image may be randomly generated. The text2image model 130 may tokenize the initial noisy image to generate a plurality of initialized noisy image tokens 203. For example, the text2image model 130 may identify patches, or different portions, of the initialized noisy image tokens 203 in a grid or other pattern that covers the initialized noisy image. Each patch may correspond to a respective image token. Typically, though not necessarily, a given patch in the pattern may not overlap with other patches. In other examples, a given patch may overlap with another patch.

The text2image model 130 may transform the text tokens 121 from the text rendering system 120 via transformer layers 234 for text self-attention to generate transformed text tokens 235. The transformed text tokens 235 may be used by the text2image model 130 for later diffusion iterations as well. The text2image model 130 may transform the initialized noisy image tokens 203 via transformer layers 236 for image self-attention to generate transformed image tokens 237. Thus, text tokens and image tokens may be separately (independently) transformed via self-attention on respective transformer layers 234 and 236.

The text2image model 130 may perform cross-attention between the transformed text tokens 235 and the transformed image tokens 237 to generated cross-attended image tokens 243. The generated cross-attended image tokens 243 include the transformed image tokens 237 that have been cross-attended with the transformed text tokens 235. In other words, the generated cross-attended image tokens 243 include information from the transformed text tokens 235. Although not shown for clarity, the text2image model 130 may process the cross-attended image tokens 243 via a Multi-Layer Perceptron (MLP) or other gating or linear processing mechanisms.

The generated cross-attended image tokens 243 of a previous diffusion iteration 232 may be used as input to a next diffusion iteration 232N. In a next diffusion iteration 232N, the transformed text tokens 235 from the previous iteration or from the initial iteration may be used. In either case, the next diffusion iteration 232N may perform self-attention on the generated cross-attended image tokens 243 to generate the transformed image tokens 237 for that iteration. The next diffusion iteration 232N may then perform cross-attention using this iteration's transformed image tokens 237 and the transformed text tokens 235. Again, further operational details such as feed forward network processing via MLP are omitted for clarity. The diffusion iterations may continue until a number of diffusion timesteps have been reached.

FIG. 3 illustrates an example of a method 300 for enhanced text adherence in a text2image model, according to an implementation. At 302, the method 300 may include accessing input text (such as input text 101) that describes an image to be generated. For example, a user may provide a prompt having input text “draw a cat sitting on a hill.” At 304, the method 300 may include generating a plurality of text tokens (such as text tokens 121) based on the input text.

At 306, the method 300 may include transform, in a first transformer layer of the text2image model (such as text self-attention 234 of the text2image model 130), the plurality of text tokens based on self-attention in which an importance of a text token is weighted relative to other ones of the plurality of text tokens.

At 308, the method 300 may include transform, in a second transformer layer of the text2image model (such as image self-attention 236 of the text2image model 130), a plurality of image tokens (such as image tokens 203 or image tokens 243) based on self-attention in which an importance of an image token is weighted relative to other ones of the plurality of image token. At 310, the method 300 may include perform cross-attention (such as cross-attention 238) between the transformed plurality of text tokens and the transformed plurality of image tokens. At 312, the method 300 may include generating an output image (such as output image 103) based on the cross-attention. Not shown for convenience are implementation details, such as processing self-attention layers through an MLP or decoding the transformed image tokens to generate the output image.

Table 1 shows an example of pseudocode for implementing an example of the method 300. The illustrated pseudocode separately executes self-attention for text tokens, separately executes self-attention for image tokens, and cross-attention for the self-attended (transformed) text tokens and transformed image tokens to improve adherence to text input.

```
class TransformerBlock(nn.Module):
  def _{——}init_{——}(do_cross_attn: bool):
    super( )._{——}init_{——}( )
    self.self_attn = Attention( )
    if do_cross_attn:
      self.cross_attn = Attention( )
    self.do_cross_attn = do_cross_attn
    self.mlp = MLP( )
  def forward(self, x, cross):
    x = self.self_attn(cx)
    if self.do_cross_attn:
      x = self.cross_attn(x, cross)
    x = self.mlp(x)
    return x
class Text2Image(nn.Module):
  def _{——}init_{——}( ):
    super( )._{——}init_{——}( )
    self.txt_in_norm = layers.RMSNorm( )
    self.txt_in = nn.Linear( )
    self.txt_out = nn.Linear( )
    self.txt_blocks = nn.ModuleList(
      [
        layers.TransformerBlock( )
        for _ in range(x)
      ]
    )
    self.blocks = nn.ModuleList(
      [
        layers.TransformerBlock(
          do_cross_attn=True
        )
        for _ in range(y)
      ]
    )
    self.final_layer = nn.Linear( )
  def _encode_text(self, text_tokens):
    txt = self.txt_in(text_tokens)
    # Normalize backbone before passing into transformer blocks for gating residuals to work best.
    txt = self.txt_in_norm(txt)
    for block in self.txt_blocks:
            txt = block(txt)
    txt = self.txt_out(txt)
    return txt, txt_mask
  def forward(self, image_tokens, text_tokens):
    txt = self._encode_text(text_tokens)
    for i, block in enumerate(self.blocks):
      image_tokens = block(image_tokens, txt)
    image_tokens = self.final_layer(image_tokens)
    return image_tokens
```

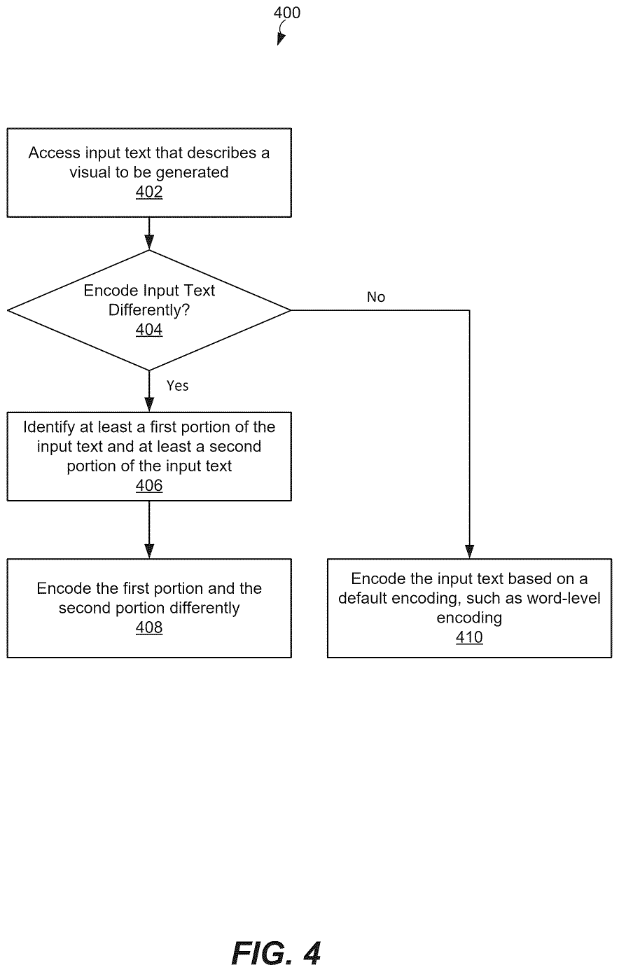

FIG. 4 illustrates an example of a method 400 for adaptive text encoding to process input text (such as input text 101) for generative text to image models (such as text2image model 132), according to an implementation. 402, the method 400 may include accessing input text to encode for a text to image model. At 404, the method 400 may include determining whether different portions of the input text should be encoded differently. For example, determining whether different portions of the input text should be encoded differently may include determining whether there exist delimiters or other indications the different portions. In particular, the delimiters or other indications may include double quotation marks. In this example, if one or more portions of the input text are surrounded by double quotation marks or other indications, then that portion of the input text may be encoded differently than portions of the input text that are not surrounded by double quotation marks.

At 406, if different portions of the input text should be encoded differently, the method 400 may include identifying at least a first portion of the input text and at least a second portion of the input text. For example, the first portion may include text that is not surrounded by double quotation marks and the first portion may include text that is surrounded by double quotation marks.

At 408, the method 400 may encode the first portion and the second portion differently. For example, the method 400 may encode the first portion by considering all of the first portion, such as by tokenizing the first portion into words or N-grams and performing word-level encoding or N-gram encoding. The method 400 may encode the second portion based on character-level (or byte-level) encoding, such as by tokenizing the second portion into individual characters and performing character-level encoding.

Returning to 404, if the input text is to be encoded the same throughout, at 410, the method 400 may encode the input text using a default encoding. The default encoding may be word-level encoding or N-gram encoding.

FIG. 5 illustrates an example of a method 500 for training a text2image model based on a transformer block architecture that modulates the magnitude of the residual blocks and normalizes it back to have a predefined magnitude, according to an implementation.

At 502, the method 500 may include receiving a backbone, a residual, and a modulation value. The backbone may include transformed image tokens from the output of a previous image self-attention layer (such as the output of a prior image self-attention layer 236 to a current image self-attention layer 236 illustrated in FIG. 2). The residual may include transformed text tokens from the text self-attention layers (such as the output of the text self-attention layers 234 illustrated in FIG. 2). The backbone and/or the residual may be modulated to ensure that the text tokens are appropriately weighted and not ignored during text2image generation. The modulation is a value that is used to modulate a gate value is a value that controls the flow of information through a network, such as the amount of the backbone and/or the residual that flows through the text2image model network.

At 504, the method 500 may include initializing the gate value. The gate value may be initialized to a predefined default value such as 1.

At 506, the method 500 may include setting the gate value based on modulation of the modulation value and add a weighting value to increase the gate value. The weighting value may be a predefined value to ensure that the modulation value is sufficiently high. For example, the weighting value may be 2.9 or other number that ensures that the gate value is sufficiently high to keep the flow of information open for the backbone and/or residual (so that one nor the other dominates).

At 508, the method 500 may include applying an activation function to the gate value. The activation function may be a non-linear activation function, such as a Sigmoid function, to bound the gate value to a number between 0 and 1.

At 510, the method 500 may include adjusting the gate value based on an epsilon hyperparameter to bring the gate value within a range defined by the epsilon hyperparameter. The epsilon hyperparameter is a predefined value to provide numerical stability. Accordingly, the epsilon hyperparameter may be set to a small, positive, to prevent gates from closing completely on one side (backbone and/or residual) or the other of the backbone and/or residual. For example, the epsilon hyperparameter may be predefined in the range of 1×10⁻³ to 1×10⁻⁸ as appropriate. Other epsilon hyperparameter values may be used as well.

At 512, the method 500 may include applying a weight to the backbone based on the gate value and weight a normalized residual based on 1 minus the gate value. For example, the gate value may be weighted based on Equation (1):

$$gate = gate * ( 1 - 2 * epsilon ) + epsilon . \qquad ( 1 )$$

At 514, the method 500 may include returning a sum of the weighted backbone and the weighted residual. An example implementation of the method 500 in pseudocode is illustrated in Table 2.

Table 2 shows an example of pseudocode for a transformer block architecture that modulates the magnitude of the residual blocks and normalizes it back to have a predefined magnitude to train the text2image model 130.

```
class GateResiduals(nn.Module):
  def _{——}init_{——}(self, epsilon):
    super( )._{——}init_{——}( )
    self.modulation = Modulation( )
    self.epsilon = epsilon
    self.norm = RMSNorm( )
  def forward(self, backbone, residual, modulation):
    # modulation layer returns scale of 1.0 at initialization.
    # we add 2.9 to have 3.9 at initialization which means 98% open gates after sigmoid.
    gate = self.modulation(modulation) + 2.9
    gate = sigmoid(gate)
    # bring the gate value to range [epsilon, 1 − epsilon] to stop gates from completely closing on one
side.
    gate = gate * (1 − 2 * self.epsilon) + self.epsilon
    # sub-magnitude preserving summation of backbone with residual activations.
    return backbone * gate + (1 − gate) * self.norm(residual)
```

As used herein throughout, the terms “visual” and “image” are used interchangeably unless expressly indicated otherwise. The use of the term “image” is not intended to denote dimensionality (2-D or 3-D) and is not intended to denote static (such as picture) versus active (such as video).

The computer system 110 may train, retrain, fine-tune, execute, or otherwise activate the text2image model 130, which may be a generative AI models. A generative AI model may be a computer model that may be trained to generate new content based on training data. In some examples, the computer system 110 may access a model API endpoint, which may be an API that provides an interface to one or more of the models. The system may activate a model via the model API endpoint. For example, to activate a model, the computer system 110 may generate or select a prompt via a prompt generator and transmit the prompt as input via the model API endpoint. The prompt generator may be a system component that receives an input and generates a prompt for execution by one or more of the models. A prompt may be an instruction to a generative AI model to generate an output. The prompt may include a query to be answered and/or a description of the output to be generated. In some instances, the prompt may also include additional information to be used by the model to generate a response. The additional information may include contextual data, desired output formats, constraints, domain-specific knowledge, examples, templates, tone, style, localization information (such as output language, consideration of cultural information, and so forth), and/or other information that may be provided to the model to help shape its response. Thus, generation of the prompt itself can be an important factor in obtaining an appropriate response from one or more of the generative AI models.

Prompts can be in the form of a text prompt for models that can understand text inputs, machine prompts for models that can understand non-text such as vector inputs, and/or other types of prompts depending on the model for which the prompt is intended.

In some instances, the prompt generator may access one or more preconfigured prompts that may be designed by a developer and/or historical prompts previously generated by one or more users. In these instances, the prompt generator may provide a user-selectable listing of the preconfigured prompts. Preconfigured prompts may be advantageous in situations in which a prompt is found to be effective and can be re-used by the same or different users and/or to simplify and streamline prompts. In some instances, the prompt generator may modify a preconfigured prompt for dynamic prompt generation based on the preconfigured prompt.

The computer system 110 may be connected to one other devices or services via a communication network (not illustrated), such as the Internet or the Internet in combination with various other networks, like local area networks, cellular networks, or personal area networks, internal organizational networks, and/or other networks. It should be noted that the computer system 110 may transmit data, via the communication network, conveying the predictions one or more client devices. The data conveying the predictions may be a user interface generated for display at the one or more client devices, one or more messages transmitted to the one or more client devices, and/or other types of data for transmission. Although not shown, the one or more client devices may each include one or more processors.

The processor 112 may include one or more of a digital processor, an analog processor, a digital circuit designed to process information, an analog circuit designed to process information, a state machine, and/or other mechanisms for electronically processing information. Although processor 112 is shown in FIG. 1 as a single entity, this is for illustrative purposes only. In some implementations, processor 112 may comprise a plurality of processing units. These processing units may be physically located within the same device, or processor 112 may represent processing functionality of a plurality of devices operating in coordination. Some or all processing units may be on-site within a computational facility and/or be located remotely such as at a cloud-based computing facility.

Processor 112 may be programmed to execute one or more computer program components. The computer program components may include software programs and/or algorithms coded and/or otherwise embedded in the processor 112. The one or more computer program components or features may include various subsystems such as 120, 130, 140, and/or other components. Processor 112 may be configured to execute or implement 120, 130, and 140 by software; hardware; firmware; some combination of software, hardware, and/or firmware; and/or other mechanisms for configuring processing capabilities on processor 112.

It should be appreciated that although 120, 130, and 140 are illustrated in FIG. 1 as being co-located in the computer system 110, one or more of 120, 130, and 140 may be located remotely from the other components or features. The description of the functionality provided by the 120, 130, and 140 described below is for illustrative purposes, and is not intended to be limiting, as any of 120, 130, and 140 may provide more or less functionality than is described, which is not to imply that other descriptions are limiting. For example, one or more of 120, 130, and 140 may be eliminated, and some or all of its functionality may be provided by others of 120, 130, and 140, again which is not to imply that other descriptions are limiting. As another example, processor 112 may include one or more additional components that may perform some or all of the functionality attributed below to one of 120, 130, and 140.

The computer system 110 may also include memory 114 in the form of electronic storage. The electronic storage may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionalities described herein.

The databases and data stores described herein (such as 111) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific implementations described herein. In addition, components of each system and each process can be practiced independent and separate from other components and processes described herein. Each component and process also can be used in combination with other assembly packages and processes. The flow charts, pseudocode, and descriptions thereof herein should not be understood to prescribe a fixed order of performing the method blocks described therein. Rather, the operations may be performed in any order that is practicable including simultaneous performance of at least some operations. Furthermore, each of the methods or pseudocode may be performed or executed in computer code by one or more of the system features illustrated in the Figures.

Clause 1. A system, comprising: a processor programmed to execute a text2image model, the processor to: access input text that describes an image to be generated; generate a plurality of text tokens based on the input text; transform, in a first transformer layer of the text2image model, the plurality of text tokens based on self-attention in which an importance of a text token is weighted relative to other ones of the plurality of text tokens; transform, in a second transformer layer of the text2image model, a plurality of image tokens based on self-attention in which an importance of an image token is weighted relative to other ones of the plurality of image tokens; perform cross-attention between the transformed plurality of text tokens and the transformed plurality of image tokens; and generate an output image based on the cross-attention.

Clause 2. The system of clause 1, wherein the text2image model comprises a diffusion model that, when executed, is to initialize an image with random noise, perform a plurality of diffusion iterations to denoise the image, and wherein each diffusion iteration executes a plurality of stacks of transformation layers, each transformation stack comprising the first transformer layer, the second transformer layer, and the cross-attention.

Clause 3. The system of clause 1, wherein to generate the plurality of text tokens, the processor is further programmed to: identify at least a first portion of the input and a second portion of the input; tokenize, based on an adaptive character-level tokenizer, the first portion via a first tokenization mechanism; and tokenize, based on an adaptive character-level tokenizer, the second portion via a second tokenization mechanism different than the first tokenization mechanism.

Clause 4. The system of clause 3, wherein to tokenize the first portion, the processor is further programmed to: split the first portion into one or more words and tokenize each word from among the one or more words.

Clause 5. The system of clause 3, wherein to tokenize the second portion, the processor is further programmed to: split the second portion into one or more characters and tokenize each character from among the one or more characters.

Clause 6. The system of clause 3, wherein the processor is further programmed to: use the first portion as a description of the image to be generated and the second portion as literal characters to be included in the image.

Clause 7. The system of clause 1, wherein a transformer block comprises a transformer block architecture that modulates the magnitude of the residual blocks and normalizes it back to have a predefined magnitude and instead of a normal summation between backbone and residual block activations.

Clause 8. The system of clause 7, wherein the processor is further programmed to: during a training phase of the text2image model, perform a gated summation between back and residual block activations to control a size of the activation norm of the backbone.

Clause 9. The system of clause 8, wherein the gated summation comprises a weighted summation controlled by a gate value.

Clause 10. The system of clause 9, wherein the gate value is a function of diffusion time.

Clause 11. A method, comprising: accessing input text that describes an image to be generated; generating a plurality of text tokens based on the input text; transforming, in a first transformer layer of a text2image model, the plurality of text tokens based on self-attention in which an importance of a text token is weighted relative to other ones of the plurality of text tokens; transforming, in a second transformer layer of the text2image model, a plurality of image tokens based on self-attention in which an importance of an image token is weighted relative to other ones of the plurality of image tokens; performing cross-attention between the transformed plurality of text tokens and the transformed plurality of image tokens; and generating an output image based on the cross-attention.

Clause 12. The method of clause 11, wherein the text2image model comprises a diffusion model that, when executed, is to initialize an image with random noise, perform a plurality of diffusion iterations to denoise the image, and wherein each diffusion iteration executes a plurality of stacks of transformation layers, each transformation stack comprising the first transformer layer, the second transformer layer, and the cross-attention.

Clause 13. The method of clause 11, wherein generating the plurality of text tokens comprises: identifying at least a first portion of the input and a second portion of the input; tokenizing, based on an adaptive character-level tokenizer, the first portion via a first tokenization mechanism; and tokenizing, based on an adaptive character-level tokenizer, the second portion via a second tokenization mechanism different than the first tokenization mechanism.

Clause 14. The method of clause 13, tokenizing the first portion comprises: splitting the first portion into one or more words and tokenizing each word from among the one or more words.

Clause 15. The method of clause 13, wherein tokenizing the second portion comprises: splitting the second portion into one or more characters and tokenize each character from among the one or more characters.

Clause 16. The method of clause 13, further comprising: using the first portion as a description of the image to be generated and the second portion as literal characters to be included in the image.

Clause 17. The method of clause 11, wherein a transformer block comprises a transformer architecture that modulates the magnitude of the residual blocks and normalizes it back to have a predefined magnitude and instead of a normal summation between backbone and residual block activations.

Clause 18. The method of clause 17, further comprising: during a training phase of the text2image model, performing a gated summation between back and residual block activations to control a size of the activation norm of the backbone.

Clause 19. The method of clause 18, wherein the gated summation comprises a weighted summation controlled by a gate value.

Clause 20. The method of clause 19, wherein the gate value is a function of diffusion time.

Clause 21. A non-transitory computer readable medium configured to store instructions, when executed on a processor, programs the processor to: access input text that describes an image to be generated; generate a plurality of text tokens based on the input text; transform, in a first transformer layer of the text2image model, the plurality of text tokens based on self-attention in which an importance of a text token is weighted relative to other ones of the plurality of text tokens; transform, in a second transformer layer of the text2image model, a plurality of image tokens based on self-attention in which an importance of an image token is weighted relative to other ones of the plurality of image tokens; perform cross-attention between the transformed plurality of text tokens and the transformed plurality of image tokens; and generate an output image based on the cross-attention.

Clause 22. A system, comprising: a processor programmed to: receive a backbone, a residual, and a modulation value; initialize a gate value; set the gate value based on modulation of the modulation value and add a weighting value to increase the gate value; applying an activation function to the gate value; adjust the gate value based on an epsilon hyperparameter to bring the gate value within a range defined by the epsilon hyperparameter; apply a weight to the backbone based on the gate value and weight a normalized residual based on 1 minus the gate value; and return a sum of the weighted backbone and the weighted residual.

Clause 23. A system, comprising: a processor programmed to: access input text to encode for a text to image model; determine that different portions of the input text should be encoded differently; identify at least a first portion of the input text and at least a second portion of the input text; tokenize the first portion based on word-level encoding or N-gram encoding; and tokenize the second portion based on character-level encoding.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to execute a text2image model, the processor to:
access input text that describes an image to be generated;
generate a plurality of text tokens based on the input text;
transform, in a first transformer layer of the text2image model, the plurality of text tokens based on self-attention in which an importance of a text token is weighted relative to other ones of the plurality of text tokens;
transform, in a second transformer layer of the text2image model, a plurality of image tokens based on self-attention in which an importance of an image token is weighted relative to other ones of the plurality of image tokens;
perform cross-attention between the transformed plurality of text tokens and the transformed plurality of image tokens; and
generate an output image based on the cross-attention.

2. The system of claim 1, wherein the text2image model comprises a diffusion model that, when executed, is to initialize an image with random noise, perform a plurality of diffusion iterations to denoise the image, and wherein each diffusion iteration executes a plurality of stacks of transformation layers, each transformation stack comprising the first transformer layer, the second transformer layer, and the cross-attention.

3. The system of claim 1, wherein to generate the plurality of text tokens, the processor is further programmed to:
identify at least a first portion of the input and a second portion of the input;
tokenize, based on an adaptive character-level tokenizer, the first portion via a first tokenization mechanism; and
tokenize, based on an adaptive character-level tokenizer, the second portion via a second tokenization mechanism different than the first tokenization mechanism.

4. The system of claim 3, wherein to tokenize the first portion, the processor is further programmed to:
split the first portion into one or more words and tokenize each word from among the one or more words.

5. The system of claim 3, wherein to tokenize the second portion, the processor is further programmed to:
split the second portion into one or more characters and tokenize each character from among the one or more characters.

6. The system of claim 3, wherein the processor is further programmed to:
use the first portion as a description of the image to be generated and the second portion as literal characters to be included in the image.

7. The system of claim 1, wherein a transformer block comprises a transformer block architecture that modulates the magnitude of the residual blocks and normalizes it back to have a predefined magnitude and instead of a normal summation between backbone and residual block activations.

8. The system of claim 7, wherein the processor is further programmed to:
during a training phase of the text2image model, perform a gated summation between back and residual block activations to control a size of the activation norm of the backbone.

9. The system of claim 8, wherein the gated summation comprises a weighted summation controlled by a gate value.

10. The system of claim 9, wherein the gate value is a function of diffusion time.

11. A method, comprising:
accessing input text that describes an image to be generated;
generating a plurality of text tokens based on the input text;
transforming, in a first transformer layer of a text2image model, the plurality of text tokens based on self-attention in which an importance of a text token is weighted relative to other ones of the plurality of text tokens;
transforming, in a second transformer layer of the text2image model, a plurality of image tokens based on self-attention in which an importance of an image token is weighted relative to other ones of the plurality of image tokens;
performing cross-attention between the transformed plurality of text tokens and the transformed plurality of image tokens; and
generating an output image based on the cross-attention.

12. The method of claim 11, wherein the text2image model comprises a diffusion model that, when executed, is to initialize an image with random noise, perform a plurality of diffusion iterations to denoise the image, and wherein each diffusion iteration executes a plurality of stacks of transformation layers, each transformation stack comprising the first transformer layer, the second transformer layer, and the cross-attention.

13. The method of claim 11, wherein generating the plurality of text tokens comprises:
identifying at least a first portion of the input and a second portion of the input;
tokenizing, based on an adaptive character-level tokenizer, the first portion via a first tokenization mechanism; and
tokenizing, based on an adaptive character-level tokenizer, the second portion via a second tokenization mechanism different than the first tokenization mechanism.

14. The method of claim 13, tokenizing the first portion comprises:
splitting the first portion into one or more words and tokenizing each word from among the one or more words.

15. The method of claim 13, wherein tokenizing the second portion comprises:
splitting the second portion into one or more characters and tokenize each character from among the one or more characters.

16. The method of claim 13, further comprising:
using the first portion as a description of the image to be generated and the second portion as literal characters to be included in the image.

17. The method of claim 11, wherein a transformer block comprises a transformer architecture that modulates the magnitude of the residual blocks and normalizes it back to have a predefined magnitude and instead of a normal summation between backbone and residual block activations.

18. The method of claim 17, further comprising:
during a training phase of the text2image model, performing a gated summation between back and residual block activations to control a size of the activation norm of the backbone.

19. The method of claim 18, wherein the gated summation comprises a weighted summation controlled by a gate value.

20. The method of claim 19, wherein the gate value is a function of diffusion time.

21. A system, comprising:
a processor programmed to:
receive a backbone, a residual, and a modulation value;
initialize a gate value;
set the gate value based on modulation of the modulation value and add a weighting value to increase the gate value;
applying an activation function to the gate value;
adjust the gate value based on an epsilon hyperparameter to bring the gate value within a range defined by the epsilon hyperparameter;
apply a weight to the backbone based on the gate value and weight a normalized residual based on 1 minus the gate value; and
return a sum of the weighted backbone and the weighted residual.

22. A system, comprising:
a processor programmed to:
access input text to encode for a text to image model;
determine that different portions of the input text should be encoded differently;
identify at least a first portion of the input text and at least a second portion of the input text;
tokenize the first portion based on word-level encoding or N-gram encoding; and
tokenize the second portion based on character-level encoding.
